(19) United States
(12) Patent Application Publication
(10) Pub. No.: US 2024/0281830 A1
(43) Pub. Date: Aug. 22, 2024

(54) IMAGE DISPLAY APPARATUS, IMAGE DISPLAY METHOD, AND NON-TRANSITORY COMPUTER-READABLE MEDIUM

(71) Applicant: NEC Corporation, Minato-ku, Tokyo (JP)

(72) Inventors: Rina TOMITA, Tokyo (JP); Yuji TAHARA, Tokyo (JP)

(73) Assignee: NEC Corporation, Minato-ku, Tokyo (JP)

(21) Appl. No.: 18/681,140

(22) PCT Filed: Aug. 23, 2021
(86) PCT No.: PCT/JP2021/030815

§ 371 Date: Feb. 5, 2024

(51) Int. Cl. G06Q 30/0201; G06T 11/20

(52) U.S. Cl. CPC G06Q 30/0201; G06T 11/206

(57) ABSTRACT

An image display apparatus includes a sales data acquisition unit, a graph generation unit, an image acquisition unit, and a display processing unit. The sales data acquisition unit acquires sales data. The sales data indicate a value related to a sales performance of a product in a store for each unit period. The graph generation unit generates a graph based on the sales data. The image acquisition unit acquires a first image. The first image is an image captured in at least one unit period (target period), and includes a display shelf where the product is arranged. The display processing unit displays the graph on a display, and also displays the first image on the display in a state where a target period being associated with the first image is determinable. Moreover, the display processing unit overlaps at least a part of the first image with the graph.

### TECHNICAL FIELD

The present invention relates to an image display apparatus, an image display method, and a program.

### BACKGROUND ART

In order to increase management efficiency of a store, it is important to recognize performance of the store. For example, Patent Document 1 describes that a graph illustrating temporal transition of a sales amount is displayed on a user terminal, and an image of a display shelf in a specified time period is displayed on the user terminal.

### RELATED DOCUMENT

### Patent Document

Patent Document 1: International Patent Publication No. WO2018/012389

### SUMMARY OF INVENTION

### Technical Problem

One of things that should be recognized in management of a store is whether a product is prepared on a display shelf. In order to recognize this, it is desirable to display an image of the display shelf. On the other hand, even when the image is displayed, it is difficult for a person viewing the image to recognize a point that the store should improve.

One example of an object of the present invention is to allow, when an image of a display shelf is displayed on a display, a person viewing the display to easily recognize a point to improve of a store.

### Solution to Problem

According to one aspect of the present invention, there is provided an image display apparatus including:
a sales data acquisition unit that acquires sales data indicating, for each unit period, a value related to a sales performance of a product in a store;
a graph generation unit that generates a graph based on the sales data;
an image acquisition unit that acquires a first image being an image captured in at least one target period being the unit period, and including a display shelf where the product is arranged; and
a display processing unit that displays the graph on a display, also displays the first image on the display in a state where the target period being associated with the first image is determinable, and overlaps at least a part of the first image with the graph.

According to one aspect of the present invention, there is provided an image display apparatus including:
an image acquisition unit that acquires an image capturing a display shelf, installed in a store, where a plurality of types of products are arranged;
an image processing unit that acquires product specification information specifying at least one type of the product, processes the image, and thereby brings a target region including the product indicated by the product specification information into a state of being distinguishable from another region within the image; and
a display processing unit that displays, on a display, the image after processed by the image processing unit.

According to one aspect of the present invention, there is provided an image display method of performing,
by a computer:
   sales data acquisition processing of acquiring sales data indicating, for each unit period, a value related to a sales performance of a product in a store;
   graph generation processing of generating a graph based on the sales data;
   image acquisition processing of acquiring a first image being an image captured in at least one target period being the unit period, and including a display shelf where the product is arranged; and
   display processing of displaying the graph on a display, also displaying the first image on the display in a state where the target period being associated with the first image is determinable, and overlapping at least a part of the first image with the graph.

According to one aspect of the present invention, there is provided an image display method of performing,
by a computer:
   image acquisition processing of acquiring an image capturing a display shelf, installed in a store, where a plurality of types of products are arranged;
   image processing of acquiring product specification information specifying at least one type of the product, processing the image, and thereby bringing a target region including the product indicated by the product specification information into a state of being distinguishable from another region within the image; and
   display processing of displaying, on a display, the image after the image processing is performed.

According to one aspect of the present invention, there is provided a program causing a computer to include:
a sales data acquisition function of acquiring sales data indicating, for each unit period, a value related to a sales performance of a product in a store;
a graph generation function of generating a graph based on the sales data;
an image acquisition function of acquiring a first image being an image captured in at least one target period being the unit period, and including a display shelf where the product is arranged; and
a display processing function of displaying the graph on a display, also displaying the first image on the display in a state where the target period being associated with the first image is determinable, and overlapping at least a part of the first image with the graph.

According to one aspect of the present invention, there is provided a program causing a computer to include:
an image acquisition function of acquiring an image capturing a display shelf, installed in a store, where a plurality of types of products are arranged;
an image processing function of acquiring product specification information specifying at least one type of the product, processing the image, and thereby bringing a target region including the product indicated by the product specification information into a state of being distinguishable from another region within the image; and
a display processing function of displaying, on a display, the image after processed by the image processing function.

### Advantageous Effects of Invention

According to one aspect of the present invention, a person viewing a display can easily recognize a point to improve of a store.

### BRIEF DESCRIPTION OF DRAWINGS

The above-described object, other objects, features, and advantageous effects will become more apparent from a preferred example embodiment described below and the following accompanying drawings.

FIG. 1 It is a diagram illustrating a functional configuration of an image display apparatus according to a first example embodiment.

FIG. 2 It is a diagram illustrating a first example of a screen displayed on a display by a display processing unit.

FIG. 3 It is a diagram illustrating a second example of a screen displayed on the display by the display processing unit.

FIG. 4 It is a diagram illustrating a third example of a screen displayed on the display by the display processing unit.

FIG. 5 It is a diagram illustrating one example of a screen displayed on the display after a unit time is switched to the time period unit.

FIG. 6 It is a diagram for describing a method of selecting a similar store.

FIG. 7 It is a diagram for describing one example of a location condition.

FIG. 8 It is a diagram illustrating a hardware configuration example of the image display apparatus.

FIG. 9 It is a flowchart illustrating one example of processing performed by the image display apparatus.

FIG. 10 It is a diagram illustrating one example of a functional configuration of an image display apparatus according to a second example embodiment.

FIG. 11 It is a diagram illustrating one example of a screen displayed on a display by a display processing unit in the second example embodiment.

FIG. 12 It is a diagram illustrating a modified example of FIG. 11.

### DESCRIPTION OF EMBODIMENTS

Hereinafter, example embodiments of the present invention are described by use of the drawings. Note that, a similar reference sign is assigned to a similar component in all the drawings, and description will not be repeated as appropriate.

### First Example Embodiment

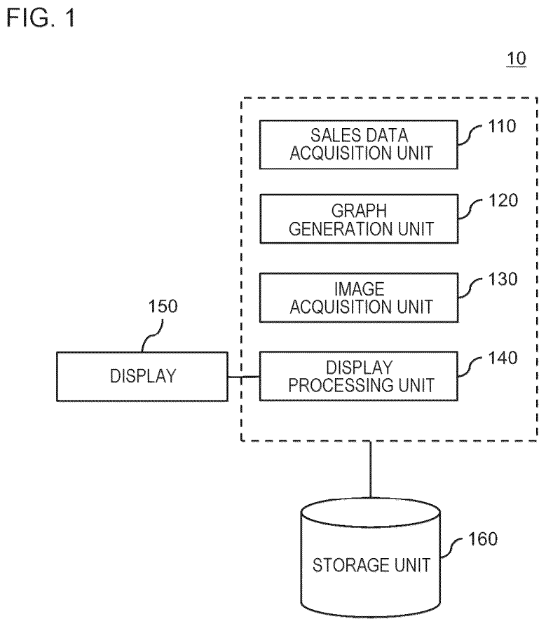

FIG. 1 is a diagram illustrating a functional configuration of an image display apparatus 10 according to the present example embodiment. The image display apparatus 10 displays an image (hereinafter, referred to as a first image) capturing a display shelf installed in a store, on a display 150 together with a graph illustrating sales data of the store. The sales data indicate a value related to a sales performance of a product in the store for each unit period. A product to be a target of the sales data is, for example, a product captured in the first image, for example, a food cooked in a store. However, the sales data may be data of the entire store. The image display apparatus 10 overlaps at least a part of the first image with the graph in a screen displayed on the display 150, and causes a unit period being associated with a capturing date and time of the first image to be determinable. Thus, a person (e.g. a shop clerk) viewing the display 150 can easily recognize a relationship between the first image and sales data at a timing when the first image is generated.

The image display apparatus 10 includes a sales data acquisition unit 110, a graph generation unit 120, an image acquisition unit 130, and a display processing unit 140.

The sales data acquisition unit 110 acquires sales data. As described above, the sales data indicate a value related to a sales performance of a product in a store for each unit period.

One example of a value related to a sales performance is at least one of the number of sales, the number of preparations, the number of stocks, the number of arranged products, the number of disposals, whether arranged products are running short, and the number of customers. The number of sales only has to be information that causes the number of products sold to be determinable. For example, the number of sales may be exactly the number of products sold, or may be the money amount of products sold. Moreover, one example of the number of preparations is the number of purchases. However, when a product to be a target is food cooked in a store, the number of preparations is the number of products cooked. The number of preparations may be any information that causes the number of prepared products to be determinable. For example, the number of preparations may be exactly the number of prepared products or the money amount of prepared products. The number of stocks is the total number of products in the store, and the number of arranged products is, out of the number of stocks, the number of items arranged in a place such as a display shelf that enables sales. The number of disposals only has to be information that causes the number of products disposed of to be determinable. For example, the number of disposals may be exactly the number of products disposed of, or may be the disposal money amount of products disposed of.

The unit period may be, for example, a quarterly unit, a monthly unit, a weekly unit, a daily unit, or a time period unit. Then, the sales data include each number in a predetermined period (hereinafter, referred to as a specified period) longer than the unit period described above. The specified period includes a plurality of the unit periods described above. When the unit period is a quarterly unit or a monthly unit, one example of the specified period is one year. When the unit period is a weekly unit, one example of the specified period is a month or a quarter. When the unit period is a daily unit, one example of the specified period is a week or a month. When the unit period is a time period unit, one example of the specified period is at least one day.

The graph generation unit 120 generates a graph based on sales data. A horizontal axis of the graph is a unit period, and a vertical axis is each value included in the sales data.

The image acquisition unit 130 acquires the first image described above. A capturing timing of the first image is included in one of the unit periods included in the sales data. Hereinafter, a unit period being associated with the first image is referred to as a target period. Herein, the image acquisition unit 130 may acquire the first image being associated with each of a plurality of unit periods.

The target period is, for example, a period in which a sales strategy of a product should be improved. The image acquisition unit 130 determines a target period by use of, for example, sales data acquired by the sales data acquisition unit 110. As one example, the image acquisition unit 130 sets a target period to a unit period in which a value indicated by the sales data satisfies a criterion. One example of a criterion used herein is at least one of the following.
1) A unit period in which a value of a specific item (e.g. a target product purchase rate) ranks high (or ranks low) within a specified period. The number of unit periods selected as a specified period herein is previously determined.
2) A unit period in which a value of a specific item (e.g. a target product purchase rate) is equal to or more than a threshold value (or equal to or less than a threshold value) within a specified period.

Moreover, the image acquisition unit 130 may acquire criterion data, and determine a target period by use of the criterion data. The criterion data indicate, for each of a plurality of unit periods included in a specified period, a criterion value in the specified period. When sales data include a plurality of items, criterion data include a criterion value of at least one (or may be all) of the plurality of items. Then, the image acquisition unit 130 sets a target period to a unit period in which a difference between a value indicated by sales data and a criterion value becomes equal to or more than a previously determined value. A generation method of criterion data is described later by use of another figure.

The display processing unit 140 displays the graph generated by the graph generation unit 120 on the display 150, and displays the first image acquired by the image acquisition unit 130 on the display 150 in a state where a target period being associated with the first image is determinable. In this instance, the display processing unit 140 overlaps at least a part of the first image with the graph.

Note that, an image capturing a display shelf is stored in the storage unit 160 in association with a capturing date and time. Moreover, sales data are also stored in the storage unit 160. Each functional unit of the image display apparatus 10 acquires necessary information from the storage unit 160. In the example illustrated in the present figure, the storage unit 160 is a part of the image display apparatus 10. However, the storage unit 160 may be located outside the image display apparatus 10.

Moreover, the display 150 may be a part of the image display apparatus 10, or may be outside the image display apparatus 10. In the former case, the image display apparatus 10 is installed, for example, in a store. In the latter case, the image display apparatus 10 may be installed in a store, or may be installed outside a store. When the image display apparatus 10 is installed outside the store, the display 150 may be a part of a terminal placed in a store.

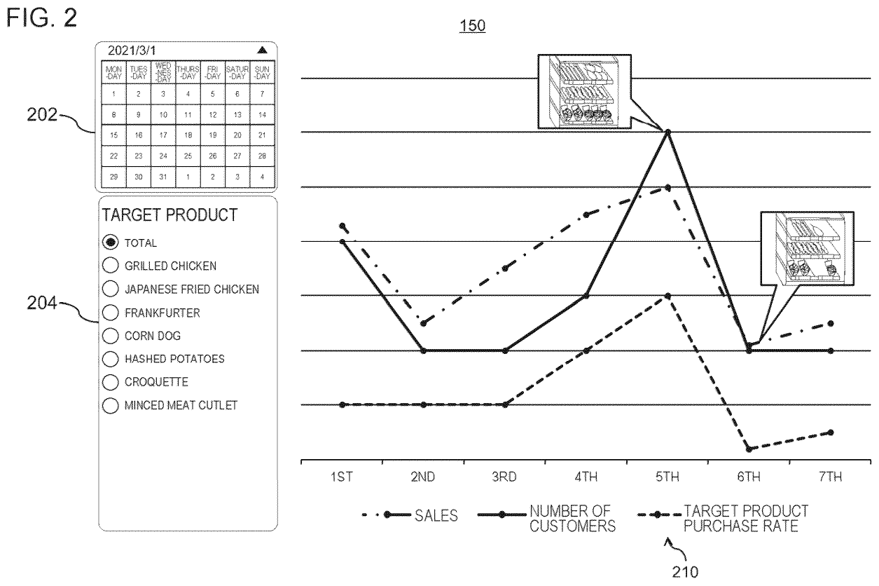

FIG. 2 is a diagram illustrating a first example of a screen displayed on the display 150 by the display processing unit 140. The screen illustrated in the present figure includes a period selection column 202, a product selection column 204, and a graph display column 210.

The period selection column 202 is a column for a clerk to input a specified period. In the example illustrated in the present figure, a month and a day to be a start point of the specified period and a month and a day to be an end point are selectable in the period selection column 202.

The item selection column 204 is a column for a clerk to select a product for which it is desired to check sales data. A plurality of products are selectable in the product selection column 204. Then, the sales data acquisition unit 110 acquires, as product specification information, information indicating the product selected in the product selection column 204.

The graph display column 210 is a column for displaying the graph and the first image. As described above, the horizontal axis of the graph is the unit period, and the vertical axis is each value included in sales data. In the example illustrated in the present figure, sales data include a sales amount, the number of customers, and a target product purchase rate. The target product purchase rate is a ratio of a customer who has purchased a product indicated by the product specification information among customers visiting a store.

In the graph display column 210, at least a part (preferably the whole) of the first image overlaps with the graph. In the example illustrated in the present figure, there are a plurality of target periods for which the first image should be displayed. Then, each of the plurality of the first images entirely overlaps with the graph. Further, for each of the plurality of the first images, a unit period (i.e. a target period) in which the first image is captured is determinable. For example, the display processing unit 140 may display, on the display 150, a mark (e.g. a line) connecting a region being associated with the target period in the graph to the first image. Moreover, the display processing unit 140 may generate a balloon region with, as a starting point, a region being associated with the target period in the graph, and display the first image in the balloon region.

Note that, a size of the graph display column 210 may be variable. In this case, the display processing unit 140 changes, according to the size of the graph display column 210, a size of the first image displayed in the graph display column 210. For example, when the graph display column 210 becomes large, the first image also becomes large. On the other hand, when the graph display column 210 becomes small, the first image also becomes small. However, the display processing unit 140 preferably prevents the size of the first image from being out of a previously determined range. The previously determined range may include only a lower limit value, or may include both a lower limit value and an upper limit value. In a case of having the lower limit value, the first image does not become too small. In a case of having the upper limit value, the first image does not become too large.

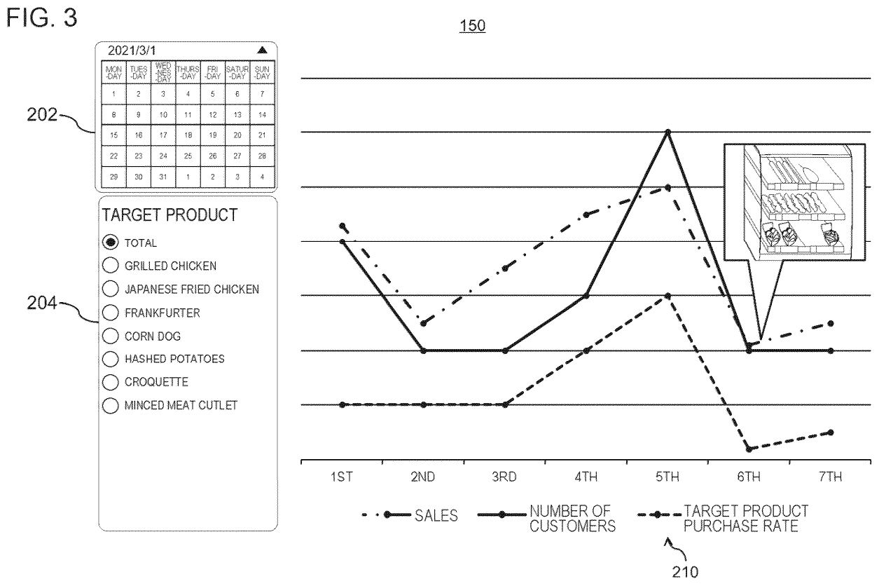

FIG. 3 is a diagram illustrating a second example of a screen displayed on the display 150 by the display processing unit 140. In the example illustrated in the present figure, the display processing unit 140 determines a size of the first image to be displayed on the display 150 by use of the number of the first images displayed on the display 150. Specifically, the display processing unit 140 enlarges the first image as the number of the first images displayed on the display 150 decreases.

For example, the display processing unit 140 first displays the screen illustrated in FIG. 2 on the display 150. Then, a user of the image display apparatus 10 selects the unnecessary first image. Accordingly, the display processing unit 140 erases the selected first image from the display 150. Accordingly, the number of first images displayed on the display 150 decreases. The display processing unit 140 enlarges the remaining first images.

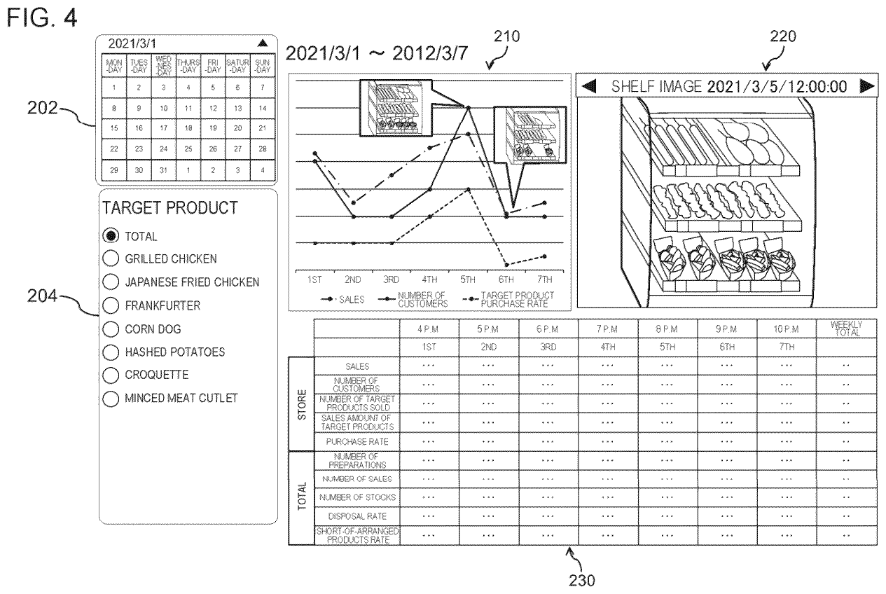

FIG. 4 is a diagram illustrating a third example of a screen displayed on the display 150 by the display processing unit 140. The screen illustrated in the present figure includes a shelf image display column 220 and a data display column 230, in addition to the period selection column 202, the product selection column 204, and the graph display column 210.

The shelf image display column 220 is a region that does not overlap with the graph display column 210, and displays the first image. The first image displayed in the shelf image display column 220 is any of the first images displayed in such a way as to overlap with the graph display column 210, and a size thereof is larger than that of the first image overlapping with the graph display column 210. For example, when one of the first images displayed in the graph display column 210 is selected, the display processing unit 140 displays the first image in the shelf image display column 220. The selection is performed by a user of the image display apparatus 10, for example, a clerk. By looking at the first image displayed in the shelf image display column 220, the user can easily recognize details of an arrangement state of a product on a display shelf in a unit period of particular interest.

The data display column 230 shows various pieces of data of a store in a specified period in a tabular form. The data displayed herein include at least an item included in sales data, and indicate a value of each item for each unit period. In the example illustrated in the present figure, the data display column 230 includes a first column that displays data relating to the entire store, and a second column that displays data relating to a target product. The first column includes the sales amount of the entire store, the number of customers, the number of sales and the sales amount of the entire target product, and the target product purchase rate described above. The second column indicates, for the entire target product, the number of preparations (e.g. the number of cooked products), the number of sales, the number of stocks (e.g. the number of uncooked products), a disposal rate, and a short-of-arranged products rate.

Herein, the short-of-arranged products rate is described. In the present example embodiment, short-of-arranged products refers to a state where the number of products is insufficient in an arrangement region of the product and a space equal to or more than a certain space is formed therebetween. In this state, it can be said that the number of products within an arrangement region is equal to or less than a previously determined number, or can be said that the products are scattered (not laid out orderly) within an arrangement region. Herein, one example of a state where a space equal to or more than a certain space is generated in an arrangement region is a state where a product is not laid in the front row of the region (a state where a product is not placed face up). Then, the short-of-arranged products rate is a ratio of a time length for which the arranged products are running short in a unit time (e.g. one hour).

Note that, whether the arranged products are running short is determined, for example, by processing the first image. One example of the processing is to determine that the arranged products are running short when a ratio of, in an image of an arrangement region, a non-product part to the entire arrangement region is equal to or more than a criterion value. Moreover, another example of the processing is to determine that the arranged products are running short when a state where a distance between adjacent products is equal to or more than a predetermined value continues a predetermined number of times in at least one of a front-rear direction and a left-right direction of an arrangement region. Note that, the image processing may be performed by the image display apparatus 10, or may be performed by an apparatus outside the image display apparatus 10.

In the example illustrated in the present figure, the unit period is a daily unit. Then, when any unit period (i.e. a day) is selected in the data display column 230, data displayed in the graph display column 210 and the data display column 230 are switched to data for each time period of the selected day. In other words, the unit time is switched from a daily unit to a time period unit.

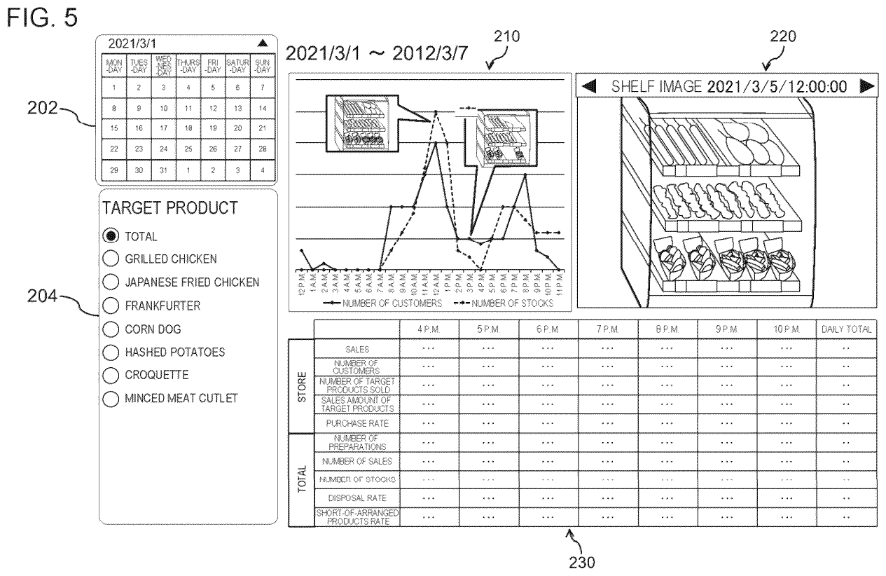

FIG. 5 is a diagram illustrating one example of a screen displayed on the display 150 after a unit time is switched to a time period unit. In the screen as well, a display function of the first image in each of the graph display column 210 and the shelf image display column 220 is as described by use of FIG. 4.

Moreover, when a specific time period is selected in the data display column 230, the display processing unit 140 may display, in the shelf image display column 220, the first image captured in the time period. In this case, the display processing unit 140 may display the selected time period in the graph display column 210 in an aspect distinguishable from another time period. As one example, the display processing unit 140 may add a specific mark to a selected time period, or may surround a selected time period with a frame. Note that, selection of a time period may be selecting any cell on a table displayed in the data display column 230 (e.g. a cell in a disposal rate or a cell in a short-of-arranged products rate in a specific time period).

When there is much disposal of products or the arranged products are running short, there may be a problem with the arrangement state (e.g. the number of arranged products) of a product in a period prior to the timing of the disposal or short-of-arranged products. Thus, when a target period is a unit period in which the number of disposals of products satisfies a criterion or a unit period in which the arranged products are running short, the image acquisition unit 130 may acquire a second image being an image capturing a display shelf before the first image. In this case, the display processing unit 140 also displays the second image on the display 150. In this instance, the display processing unit 140 may overlap at least a part (e.g. the entirety) of the second image with a graph. The second image may be displayed side by side with the first image, or may be displayed apart from the first image.

Note that, a difference between a unit period (i.e. a timing at which the first image is captured) being associated with the first image and a unit period (i.e. a timing at which the second image is captured) being associated with the second image is, for example, equal to or more than 5 minutes and within 12 hours, but not limited to this range. As one example, when it is desired to check a daily flow of a store, the difference is 1 hour, but when it is desired to check a state of a store in a time period in which the number of visitors peaks, the difference is 10 minutes.

Moreover, there may be a plurality of second images. In this case, the plurality of second images are preferably captured at timings different from each other (e.g. captured at a predetermined time interval). As one example, when it is desired to check a daily flow of a store, the interval is 1 hour, but when it is desired to check a state of a store in a time period in which the number of visitors peaks, the interval is 10 minutes.

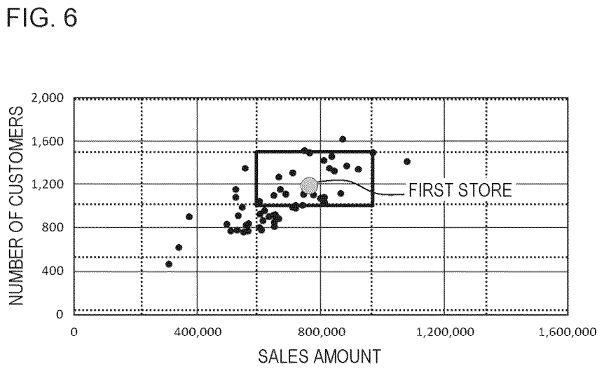

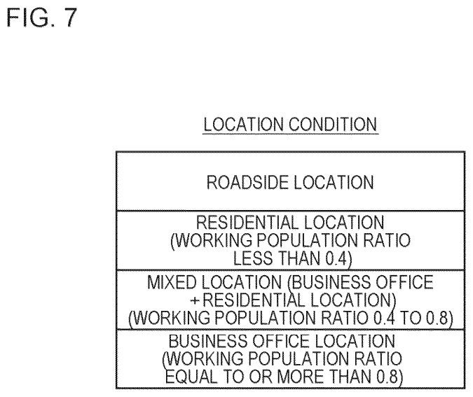

Next, a generation method of criterion data described by use of FIG. 1 is described by use of FIGS. 6 and 7. The criterion data are generated by use of data of a store (hereinafter, referred to as a similar store) similar in attribute to a store (referred to as a target store in the description relating to FIGS. 6 to 8) being a processing target of the image display apparatus 10. An attribute includes, for example, a location condition and a sales tendency. The number of similar stores may be one or a plurality.

FIG. 6 is a diagram for describing a method of selecting a similar store. A plurality of stores being capable of becoming similar stores are previously clustered by use of a plurality of conditions. The population of the clustering consists of, for example, stores with a similar location condition among stores located within the local government (a prefecture or a municipality) to which a target store belongs. Then, each of a plurality of stores belonging to the same cluster as a target store is selected as a similar store. Information determining the population is stored in the storage unit 160.

In the example illustrated in the present figure, a condition used at clustering relates to a sales tendency. One example of a condition relating to a sales tendency is the number of customers and a sales amount. The sales amount may be a sales amount on a store basis, or may be a sales amount of a product indicated by product specification information.

FIG. 7 is a diagram for describing one example of a location condition. A location condition is first classified according to whether the store is located on a roadside, for example, whether the store faces a main road. Further, a store that is not located on a roadside is further classified by use of a working population ratio. One example of the working population ratio is [a working population around a store]/[(the number of households around the store)+(a working population around the store)]. Note that, “around the store” means being within a certain range from the store, for example, being within a predetermined time on foot from the store. In the example illustrated in the present figure, a store that is not located on a roadside is classified into any of three groups being a residential location, a mixed location, and a business office location.

Then, the criterion data are generated by use of data of a similar store. The criterion data are a criterion value set for each unit period, as described above. The criterion values are generated, for example, by statistically processing data of each of a plurality of similar stores.

For example, the criterion value is set by use of a performance value of each of a plurality of stores (hereinafter, referred to as criterion stores) with a high sales amount and a small number of disposals among stores (i.e. similar stores described above) belonging to the same cluster as a target store. Specifically, the criterion value is computed by a multiple regression analysis using a performance value of a criterion store. In the multiple regression analysis, an objective variable is the number of sales (e.g. the number of sales by time period). Moreover, one example of an explanatory variable is an attribute of a unit period (e.g. a day of a week), the number of customers, and a traffic volume of an area to which the store belongs. Data used for the multiple regression analysis are stored in the storage unit 160.

When the multiple regression analysis described above is used, assumed data including at least one of the number of customers of a target store in the unit period and a traffic volume in an area to which the target store belongs are necessary. The assumed data are computed by use of actual results in the number of customers and traffic volume of the area in the past. The actual results used herein are actual results in a period (e.g. the same day of a week) having the same attribute as the unit period. Note that, the number of criterion stores may be one or a plurality.

Note that, computation processing of the above-described criterion data may be performed by the image display apparatus 10, or may be performed by an apparatus different from the image display apparatus 10.

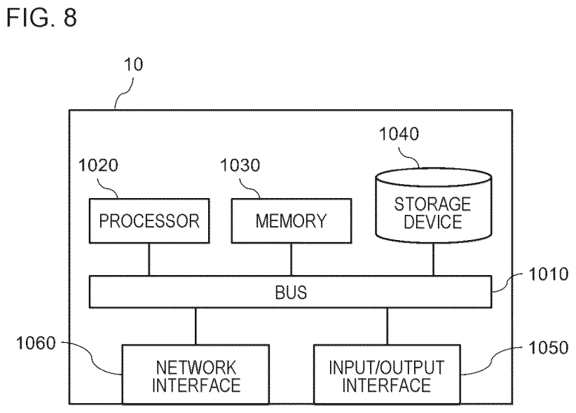

FIG. 8 is a diagram illustrating a hardware configuration example of the image display apparatus 10. The image display apparatus 10 includes a bus 1010, a processor 1020, a memory 1030, a storage device 1040, an input/output interface 1050, and a network interface 1060.

The bus 1010 is a data transmission path through which the processor 1020, the memory 1030, the storage device 1040, the input/output interface 1050, and the network interface 1060 transmit and receive data to and from each other. However, a method of connecting the processor 1020 and the like to each other is not limited to bus connection.

The processor 1020 is a processor achieved by a central processing unit (CPU), a graphics processing unit (GPU), or the like.

The memory 1030 is a main storage apparatus achieved by a random access memory (RAM) or the like.

The storage device 1040 is an auxiliary storage apparatus achieved by a hard disk drive (HDD), a solid state drive (SSD), a memory card, a read only memory (ROM), or the like. The storage device 1040 stores a program module that achieves each function (e.g. the sales data acquisition unit 110, the graph generation unit 120, the image acquisition unit 130, and the display processing unit 140) of the image display apparatus 10. The processor 1020 reads each of the program modules onto the memory 1030, executes the read program module, and thereby achieves each function being associated with the program module. Moreover, the storage device 1040 also functions as the storage unit 160.

The input/output interface 1050 is an interface for connecting the image display apparatus 10 to various kinds of input/output equipment.

The network interface 1060 is an interface for connecting the image display apparatus 10 to a network. The network is, for example, a local area network (LAN), a wide area network (WAN), or the like. A method of connecting the network interface 1060 to the communication network may be wireless connection, or may be wired connection.

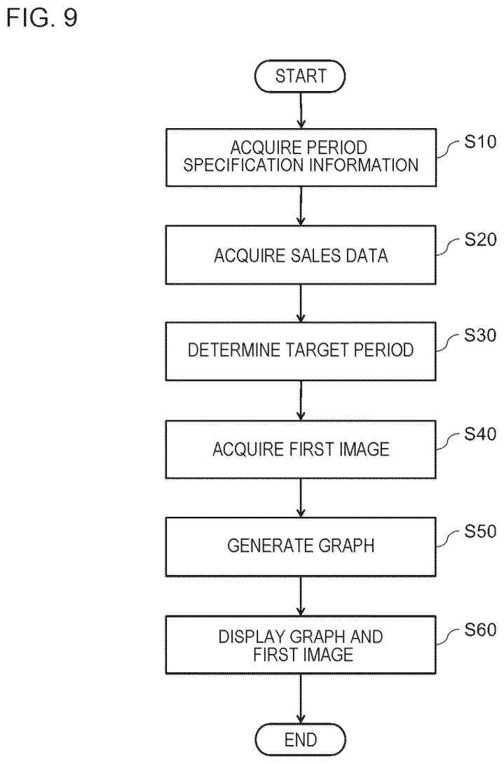

FIG. 9 is a flowchart illustrating one example of processing performed by the image display apparatus 10. First, the image display apparatus 10 displays an initial screen. The screen includes, for example, the period selection column 202 and the product selection column 204 illustrated in FIG. 2. A clerk at a first store inputs product specification information and period specification information to the image display apparatus 10 via the period selection column 202 and the product selection column 204 (step S10).

The sales data acquisition unit 110 acquires, from the storage unit 160, sales data of a product being associated with the product specification information. The sales data acquired herein are the data in a period indicated by the period specification information (step S20).

Next, the image acquisition unit 130 determines, by use of the sales data acquired in step S20, a target period for which the first image should be displayed (step S30), and acquires a first image being associated with the determined target period from the storage unit 160 (step S40).

The graph generation unit 120 generates a graph by use of the sales data (step S50). Then, the display processing unit 140 displays, on the display 150, the graph generated in step S50 and the first image acquired in step S40. In this instance, at least a part of the first image overlaps with the graph (step S60). Moreover, in a screen displayed on the display 150, for the first image, a unit period being associated with a capturing date and time of the first image is determinable.

As described above, according to the present example embodiment, the display 150 displays a graph indicating sales data, and a first image capturing a display shelf. In this instance, at least a part of the first image overlaps with the graph. Then, for the first image, a unit period being associated with a capturing date and time of the first image is determinable. Thus, a relationship between a first image and the sales data at a timing when the first image is generated is easy to understand. Therefore, a person viewing the display 150 can easily recognize a point that the store should improve.

### Second Example Embodiment

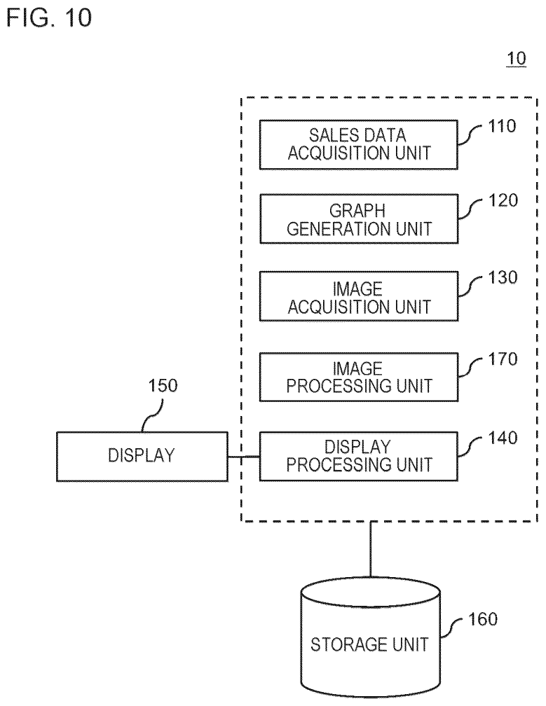

FIG. 10 is a diagram illustrating one example of a functional configuration of an image display apparatus 10 according to the present example embodiment. The image display apparatus 10 illustrated in the present figure is similar to the image display apparatus 10 according to the first example embodiment except for the following point.

First, the image display apparatus 10 includes an image processing unit 170. When product specification information is input to the image display apparatus 10, the image processing unit 170 processes a first image, and thereby brings a region (hereinafter, referred to as a target region) including a product indicated by the product specification information into a state of being distinguishable from another region, for example, a highlighted state within the first image. As one example, the image processing unit 170 superimposes, on the first image, at least one of a frame surrounding the target region and a mark determining the target region. Moreover, the image processing unit 170 may turn a region other than the target region in the first image into black and white display, translucency, or low resolution.

Then, a display processing unit 140 displays, on the display 150, the first image after processed by the image processing unit 170. In this instance, the display processing unit 140 displays the first image on the display 150 in an aspect similar to that according to the first example embodiment.

Note that, the image processing unit 170 may determine a target region by processing the first image. In this case, for example, the image processing unit 170 may determine a target region using a feature value of a product indicated by the product specification information, or may determine a target region using a model generated by machine learning.

Moreover, when relative positions of an imaging apparatus that generates the first image and a display shelf are fixed, a position of each of a plurality of types of products within the first image is fixed. In this case, the image processing unit 170 may acquire address information indicating a position of each product within the first image, and determine a target region by use of the information. The address information is stored in, for example, a storage unit 160. Note that, when a shelf label for each product is installed on a display shelf, and a mark or a code (e.g. a two-dimensional code) for each product is attached to the shelf label, the image processing unit 170 may process the first image, detect a mark or a code thereof, and generate address information.

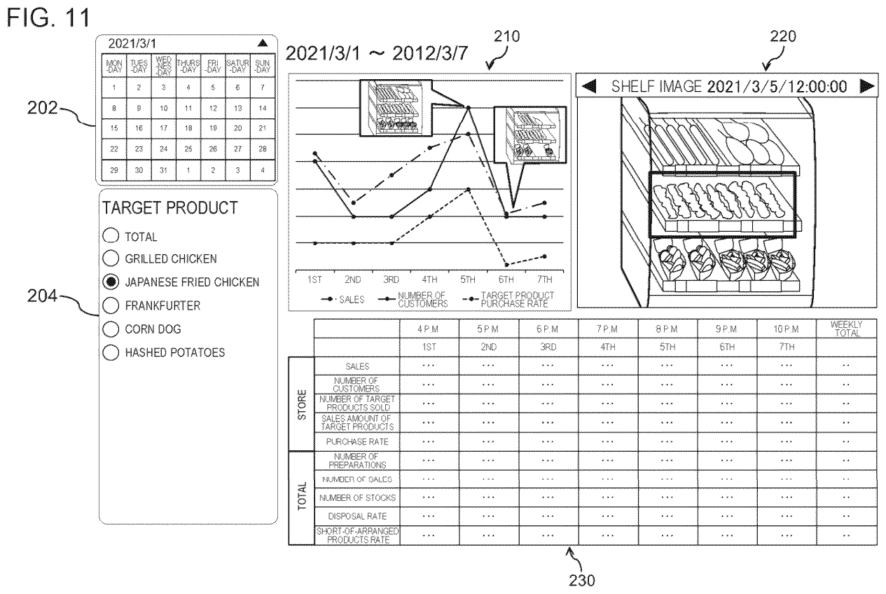

FIG. 11 is a diagram illustrating one example of a screen displayed on the display 150 by the display processing unit 140 in the present example embodiment. In the example illustrated in the present figure, a shelf image display column 220 displays the first image after processed by the image processing unit 170. Note that, the first image overlapping with a graph display column 210 may be a first image before processed by the image processing unit 170, or may be a first image after processed by the image processing unit 170.

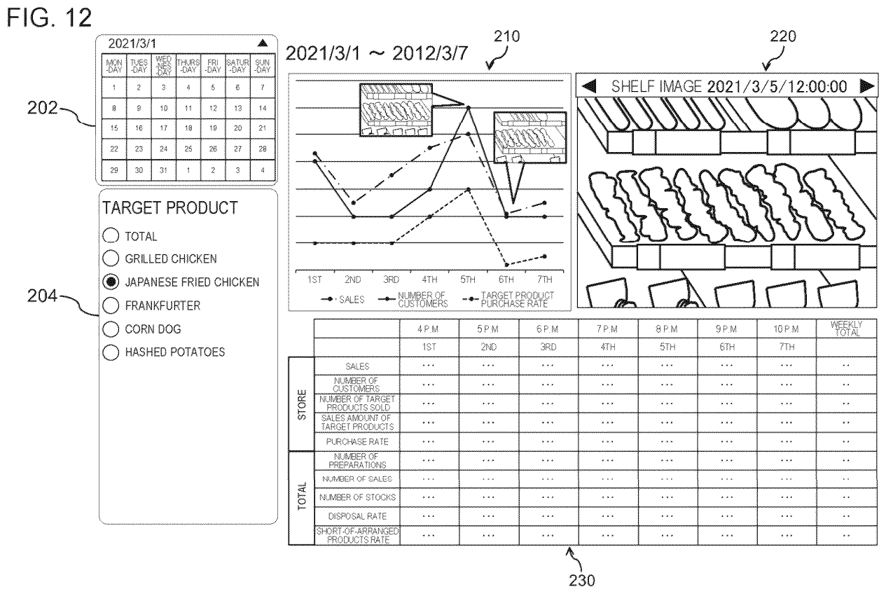

FIG. 12 is a diagram illustrating a modified example of FIG. 11. As illustrated in the present figure, the display processing unit 140 may display, on the display 150, an image (hereinafter, referred to as a partial image) acquired by cutting out the target region from the first image, instead of the first image. Herein, the display processing unit 140 may display one of the first image and the partial image in the graph display column 210, and display the other of the first image and the partial image in the shelf image display column 220. In the example illustrated in FIG. 12, the display processing unit 140 displays the partial image in the graph display column 210, and displays the first image in the shelf image display column 220.

According to the present example embodiment, in the first image, the target region being a region in which a product indicated by the product specification information is captured is displayed in a state of being distinguishable from another region. Therefore, a person viewing the display 150 can easily recognize a stock state of a product at a timing when the first image is generated. Therefore, it becomes easy for the person to recognize a point that the store should improve.

The example embodiments of the present invention have been described above with reference to the drawings, but are exemplifications of the present invention, and various configurations other than those described above can also be adopted.

Moreover, although a plurality of steps (pieces of processing) are described in order in a plurality of flowcharts used in the above description, an execution order of steps executed in each example embodiment is not limited to the described order. In each example embodiment, an order of illustrated steps can be changed to an extent that causes no problem in terms of content. Moreover, each of the example embodiments described above can be combined as long as the content does not contradict.

Some or all of the above-described example embodiments can also be described as, but are not limited to, the following supplementary notes.

1. An image display apparatus including:
a sales data acquisition unit that acquires sales data indicating, for each unit period, a value related to a sales performance of a product in a store;
a graph generation unit that generates a graph based on the sales data;
an image acquisition unit that acquires a first image being an image captured in at least one target period being the unit period, and including a display shelf where the product is arranged; and
a display processing unit that displays the graph on a display, also displays the first image on the display in a state where the target period being associated with the first image is determinable, and overlaps at least a part of the first image with the graph.
   2. The image display apparatus according to supplementary note 1, in which
the value related to the sales performance includes at least one of the number of sales, the number of preparations, the number of disposals, whether the arranged product is running short, and the number of customers.
   3. The image display apparatus according to supplementary note 1 or 2, in which
the image acquisition unit determines the target period by use of the sales data.
   4 The image display apparatus according to supplementary note 3, in which
the image acquisition unit sets the target period to the unit period in which the value satisfies a criterion.
   5. The image display apparatus according to supplementary note 3, in which
the image acquisition unit
   acquires a criterion value of the value for each of the plurality of unit periods, and
   sets the target period to the unit period in which a difference between the value indicated by the sales data and the criterion value is equal to or more than a previously determined value.
      6. The image display apparatus according to any one of supplementary notes 1 to 5, in which
the unit period is a time period,
the target period is the unit period in which the number of disposals of the products satisfies a criterion, or the unit period in which the arranged product is running short,
the image acquisition unit acquires a second image being an image capturing the display shelf before the first image, and
the display processing unit further displays the second image on the display.
   7. The image display apparatus according to any one of supplementary notes 1 to 6, in which
a plurality of the target periods are present,
the image acquisition unit acquires the first image for each of the plurality of target periods, and
the display processing unit determines a size of the first image on the display by use of the number of the first images displayed on the display.
   8. The image display apparatus according to any one of supplementary notes 1 to 7, in which
a size of the graph is variable on the display, and
the display processing unit changes a size of the first image displayed on the display within a previously determined range according to a size of the graph.
   9. The image display apparatus according to any one of supplementary notes 1 to 8, in which
the display processing unit
   provides the display with an image display region being a region that does not overlap with the graph and displaying the first image, and,
   when the first image overlapping with the graph is selected, displays the first image in the image display region.
      10. An image display apparatus including:
an image acquisition unit that acquires an image capturing a display shelf, installed in a store, where a plurality of types of products are arranged;
an image processing unit that acquires product specification information specifying at least one type of the product, processes the image, and thereby brings a target region including the product indicated by the product specification information into a state of being distinguishable from another region within the image; and
a display processing unit that displays, on a display, the image after processed by the image processing unit.
   11. The image display apparatus according to supplementary note 10, in which
the image processing unit superimposes, on the image, at least one of a frame surrounding the target region and a mark determining the target region.
   12. The image display apparatus according to supplementary note 10 or 11, in which
the display processing unit further cuts out the target region from the image, and displays the target region on the display.
   13. The image display apparatus according to supplementary note 12, further including:
a sales data acquisition unit that acquires sales data indicating, for each unit period, a value related to a sales performance of a product in the store; and
a graph generation unit that generates a graph based on the sales data, in which
the image is captured in any of the unit periods, and
the display processing unit displays the graph on a display, also displays the target region on the display in a state where the unit period being associated with the target region is determinable, and overlaps at least a part of the target region with the graph.
   14. An image display method including,
by a computer, performing:
   sales data acquisition processing of acquiring sales data indicating, for each unit period, a value related to a sales performance of a product in a store;
   graph generation processing of generating a graph based on the sales data;
   image acquisition processing of acquiring a first image being an image captured in at least one target period being the unit period, and including a display shelf where the product is arranged; and
   display processing of displaying the graph on a display, also displaying the first image on the display in a state where the target period being associated with the first image is determinable, and overlapping at least a part of the first image with the graph.
      15. The image display method according to supplementary note 14, in which
the value related to the sales performance includes at least one of the number of sales, the number of preparations, the number of disposals, whether the arranged product is running short, and the number of customers.
   16. The image display method according to supplementary note 14 or 15, further including
by the computer, in the image acquisition processing, determining the target period by use of the sales data.
   17. The image display method according to supplementary note 16, further including
by the computer, in the image acquisition processing, setting the target period to the unit period in which the value satisfies a criterion.
   18. The image display method according to supplementary note 16, further including
by the computer, in the image acquisition processing:
   acquiring a criterion value of the value for each of the plurality of unit periods; and
   setting the target period to the unit period in which a difference between the value indicated by the sales data and the criterion value is equal to or more than a previously determined value.
      19. The image display method according to any one of supplementary notes 14 to 18, in which
the unit period is a time period, and
the target period is the unit period in which the number of disposals of the products satisfies a criterion, or the unit period in which the arranged product is running short,
the image display method further including,
by the computer:
   in the image acquisition processing, acquiring a second image being an image capturing the display shelf before the first image; and
   in the display processing, further displays the second image on the display.
      20. The image display method according to any one of supplementary notes 14 to 19, in which
a plurality of the target periods are present,
the image display method further including,
by the computer:
   in the image acquisition processing, acquiring the first image for each of the plurality of target periods; and
   in the display processing, determining a size of the first image on the display by use of the number of the first images displayed on the display.
      21. The image display method according to any one of supplementary notes 14 to 20, in which
a size of the graph is variable on the display,
the image display method further including,
by the computer, in the display processing, changing a size of the first image displayed on the display within a previously determined range according to a size of the graph.
   22. The image display method according to any one of supplementary notes 14 to 21, further including,
by the computer, in the display processing:
   providing the display with an image display region being a region that does not overlap with the graph and displaying the first image; and,
   when the first image overlapping with the graph is selected, displaying the first image in the image display region.
      23. An image display method comprising,
by a computer, performing:
   image acquisition processing of acquiring an image capturing a display shelf, installed in a store, where a plurality of types of products are arranged;
   image processing of acquiring product specification information specifying at least one type of the product, processing the image, and thereby bringing a target region including the product indicated by the product specification information into a state of being distinguishable from another region within the image; and
   display processing of displaying, on a display, the image after the image processing is performed.
      24. The image display method according to supplementary note 23, further including,
by the computer, in the image processing, superimposing, on the image, at least one of a frame surrounding the target region and a mark determining the target region.
   25. The image display method according to supplementary note 23 or 24, further including,
by the computer, in the display processing, further cutting out the target region from the image, and displaying the target region on the display.
   26. The image display method according to supplementary note 25, further including,
by the computer, performing:
   sales data acquisition processing of acquiring sales data indicating, for each unit period, a value related to a sales performance of a product in the store; and
   graph generation processing of generating a graph based on the sales data, in which
the image is captured in any of the unit periods,
the image display method further including,
by the computer, in the display processing, displaying the graph on a display, also displaying the target region on the display in a state where the unit period being associated with the target region is determinable, and overlapping at least a part of the target region with the graph.
   27. A program causing a computer to include:
a sales data acquisition function of acquiring sales data indicating, for each unit period, a value related to a sales performance of a product in a store;
a graph generation function of generating a graph based on the sales data;
an image acquisition function of acquiring a first image being an image captured in at least one target period being the unit period, and including a display shelf where the product is arranged; and
a display processing function of displaying the graph on a display, also displaying the first image on the display in a state where the target period being associated with the first image is determinable, and overlapping at least a part of the first image with the graph.
   28. The program according to supplementary note 27, in which
the value related to the sales performance includes at least one of the number of sales, the number of preparations, the number of disposals, whether the arranged product is running short, and the number of customers.
   29. The program according to supplementary note 28 or 28, in which
the image acquisition function determines the target period by use of the sales data.
   30. The program according to supplementary note 29, in which
the image acquisition function sets the target period to the unit period in which the value satisfies a criterion.
   31. The program according to supplementary note 29, in which
the image acquisition function
   acquires a criterion value of the value for each of the plurality of unit periods, and
   sets the target period to the unit period in which a difference between the value indicated by the sales data and the criterion value is equal to or more than a previously determined value.
      32. The program according to any one of supplementary notes 27 to 31, in which
the unit period is a time period,
the target period is the unit period in which the number of disposals of the products satisfies a criterion, or the unit period in which the arranged product is running short,
the image acquisition function acquires a second image being an image capturing the display shelf before the first image, and
the display processing function further displays the second image on the display.
   33. The program according to any one of supplementary notes 27 to 32, in which
a plurality of the target periods are present,
the image acquisition function acquires the first image for each of the plurality of target periods, and
the display processing function determines a size of the first image on the display by use of the number of the first images displayed on the display.
   34. The program according to any one of supplementary notes 27 to 33, in which
a size of the graph is variable on the display, and
the display processing function changes a size of the first image displayed on the display within a previously determined range according to a size of the graph.
   35. The program according to any one of supplementary notes 27 to 34, in which
the display processing function
   provides the display with an image display region being a region that does not overlap with the graph and displaying the first image, and,
   when the first image overlapping with the graph is selected, displays the first image in the image display region.
      36. A program causing a computer to include:
an image acquisition function of acquiring an image capturing a display shelf, installed in a store, where a plurality of types of products are arranged;
an image processing function of acquiring product specification information specifying at least one type of the product, processing the image, and thereby bringing a target region including the product indicated by the product specification information into a state of being distinguishable from another region within the image; and
a display processing function of displaying, on a display, the image after processed by the image processing function.
   37. The program according to supplementary note 36, in which
the image processing function superimposes, on the image, at least one of a frame surrounding the target region and a mark determining the target region.
   38. The program according to supplementary note 36 or 37, in which
the display processing function further cuts out the target region from the image, and displays the target region on the display.
   39. The program according to supplementary note 38, further causing the computer to include:
a sales data acquisition function of acquiring sales data indicating, for each unit period, a value related to a sales performance of a product in the store; and
a graph generation function of generating a graph based on the sales data, in which
the image is captured in any of the unit periods, and
the display processing function displays the graph on a display, also displays the target region on the display in a state where the unit period being associated with the target region is determinable, and overlaps at least a part of the target region with the graph.

### REFERENCE SIGNS LIST

10 Image display apparatus
110 Sales data acquisition unit
120 Graph generation unit
130 Image acquisition unit
140 Display processing unit
150 Display
160 Storage unit
170 Image processing unit

What is claimed is:

1. An image display apparatus comprising:
at least one memory configured to store instructions; and
at least one processor configured to execute the instructions to perform operations comprising:
acquiring sales data indicating, for each unit period, a value related to a sales performance of a product in a store;
generating a graph based on the sales data;
acquiring a first image being an image captured in at least one target period being the unit period, and including a display shelf where the product is arranged; and
displaying the graph on a display, also displaying the first image on the display in a state where the target period being associated with the first image is determinable, and overlapping at least a part of the first image with the graph.

2. The image display apparatus according to claim 1, wherein
the value related to the sales performance includes at least one of the number of sales, the number of preparations, the number of disposals, whether the arranged product is running short, and the number of customers.

3. The image display apparatus according to claim 1, wherein
the operations further comprise determining the target period by use of the sales data.

4. The image display apparatus according to claim 3, wherein
the operations further comprise setting the target period to the unit period in which the value satisfies a criterion.

5. The image display apparatus according to claim 3, wherein
the operations further comprise
acquiring a criterion value of the value for each of a plurality of the unit periods, and
setting the target period to the unit period in which a difference between the value indicated by the sales data and the criterion value is equal to or more than a previously determined value.

6. The image display apparatus according to claim 1, wherein
the unit period is a time period,
the target period is the unit period in which the number of disposals of the products satisfies a criterion, or the unit period in which the arranged product is running short, and
the operations further comprise
acquiring a second image being an image capturing the display shelf before the first image, and
displaying the second image on the display.

7. The image display apparatus according to claim 1, wherein
a plurality of the target periods are present, and
the operations further comprise
acquiring the first image for each of the plurality of target periods, and
determining a size of the first image on the display by use of the number of the first images displayed on the display.

8. The image display apparatus according to claim 1, wherein
a size of the graph is variable on the display, and
the operations further comprise changing a size of the first image displayed on the display within a previously determined range according to a size of the graph.

9. The image display apparatus according to claim 1, wherein
the operations further comprise
providing the display with an image display region being a region that does not overlap with the graph and displaying the first image, and,
when the first image overlapping with the graph is selected displaying the first image in the image display region.

10-13. (canceled)

14. An image display method comprising,
by a computer, performing:
sales data acquisition processing of acquiring sales data indicating, for each unit period, a value related to a sales performance of a product in a store;
graph generation processing of generating a graph based on the sales data;
image acquisition processing of acquiring a first image being an image captured in at least one target period being the unit period, and including a display shelf where the product is arranged; and
display processing of displaying the graph on a display, also displaying the first image on the display in a state where the target period being associated with the first image is determinable, and overlapping at least a part of the first image with the graph.

15. (canceled)

16. A non-transitory computer-readable medium storing a program for causing a computer to perform operations comprising:
acquiring sales data indicating, for each unit period, a value related to a sales performance of a product in a store;
generating a graph based on the sales data;
acquiring a first image being an image captured in at least one target period being the unit period, and including a display shelf where the product is arranged; and
displaying the graph on a display, also displaying the first image on the display in a state where the target period being associated with the first image is determinable, and overlapping at least a part of the first image with the graph.

17. (canceled)
